(19) United States
(12) Patent Application Publication
(10) Pub. No.: US 2012/0211474 A1
(43) Pub. Date: Aug. 23, 2012

(54) LASER LAP WELDING METHOD

(75) Inventors: Kazuhiro Hayashimoto, Shizuoka-ken (JP); Yuta Fujinuma, Shizuoka-ken (JP); Tsukasa Hagihara, Shizuoka-ken (JP); Yoshitaka Sanuki, Shizuoka-ken (JP)

(73) Assignee: SUZUKI MOTOR CORPORATION, Shizuoka-ken (JP)

(21) Appl. No.: 13/372,601

(22) Filed: Feb. 14, 2012

(30) Foreign Application Priority Data
Feb. 22, 2011 (JP) 2011-036174

(51) Int. Cl. B23K 26/24; B23K 26/06

(52) U.S. Cl. 219/121.64; 219/121.73

(57) ABSTRACT

To provide a laser lap welding method including: performing lap welding (11; 21) by irradiating a laser beam (La) on a plurality of overlapped workpieces (1, 2); and irradiating, after a very short interruption time period of the laser beam irradiation, a defocused laser beam (Lc) on a terminating end (12; 22) of the lap welding. Preferably, the laser lap welding method including: interrupting the irradiation of the laser beam for a very short time period and moving, during the interruption time period, the optical axis of the laser beam from the terminating end of the lap welding to the side of the starting end of the lap welding; and irradiating a defocused laser beam from the position to which the optical axis of the laser beam is moved, to the terminating end of the lap welding.

### CROSS-REFERENCE TO RELATED APPLICATIONS

The present application claims priority to Japanese Patent Application No. 2011-036174, filed Feb. 22, 2011, which is incorporated herein in its entirety.

### FIELD OF THE INVENTION

The present invention relates to a laser lap welding method, and more particularly to a laser lap welding method which improves a hole, an indentation, and the like, that are caused at a welding terminating end.

### BACKGROUND OF THE INVENTION

A laser welding method, in which a laser beam is irradiated onto a workpiece to heat and melt a material of the irradiated portion by the light energy of the laser beam, has an advantage in that high speed welding can be performed in a non-contact manner, but has a problem in that a hole and an indentation are caused at a welding terminating end. Thus, this problem has become one of the factors that limit the use of the laser welding method to only some automobile parts and prevents the laser welding method from being used for the vehicle body welding process in which strict management of performance and quality about airtightness, water leakage, and the like, is required.

The perforation and indentation, which are caused in a laser welding terminating end, are caused by molten metal supplied to the welding terminating end eventually becoming insufficient due to a phenomenon in which the molten metal flows in the direction opposite to the welding advancing direction. As a measure to solve this problem, there is known, as disclosed in JP2007-313544A, a method which is referred to as “ramping” or “fade down” and in which the laser output is controlled to be gradually reduced toward the welding terminating end.

For example, as shown in FIG. 6(A) and FIG. 6(B), in the case in which two galvanized steel sheets 1 and 2 are overlapped and laser-welded to each other, when the laser output P is maintained at a constant level until the laser beam reaches the welding terminating end, a hole 52 is generated at the end of a weld bead 51, and the substantial welding length Wa becomes shorter than the laser irradiation length L by the length corresponding to the hole 52.

On the other hand, as shown by the solid line (61) in FIG. 6(C) and FIG. 6(D), when the laser output P is gradually reduced toward the welding terminating end, since the penetration depth is gradually reduced, the frequency of occurrence of the perforation at the end of the weld bead 61 is reduced. However, even with this method, the perforation cannot be completely prevented. Even in the case in which the perforation is not caused, a comparatively deep indentation 62 is left at the welding terminating end, and also the substantial welding length Wa′ is further reduced. Thus, when this welding method is used as it is, a reduction in strength, and the like, is caused at the welding terminating end, so that the welding quality is inevitably affected. In order to avoid this problem, it is also conceivable to increase the welding length (L″) as shown by a broken line (71) in FIG. 6(C) and FIG. 6(D). However, in this case, a space required for the weld bead 71 is increased.

As another measure against the above-described problems, a method is disclosed in JP2008-264793A in which the laser irradiation diameter is increased at the welding terminating end by defocusing the laser beam. However, as shown in FIG. 1 of JP2008-264793A, when, at the welding terminating end, the laser beam is stopped and defocused to increase the laser irradiation diameter, new defects, such as burn-through of the upper steel sheet and the spattering of molten metal, may be induced instead of an improvement in the hole and indentation. Furthermore, there arises a problem in that, when the laser irradiation diameter is increased before the laser beam reaches the welding terminating end, the energy density of the laser beam is reduced and thereby the substantial welding length is reduced, similarly to the case in which the above-described method is used.

### BRIEF SUMMARY OF THE INVENTION

The present invention has been made in view of the above-described circumstances. An object of the present invention is to provide a laser lap welding method which can improve the hole and indentation at the welding terminating end while avoiding an increase in the space and the cycle time that are required to secure the welding length.

In order to solve the above-described problems, a laser lap welding method according to the present invention includes: performing lap welding (11; 21) by irradiating a laser beam (La) on a plurality of overlapped workpieces (1, 2); and then irradiating, after a very short interruption time period of the laser irradiation, a defocused laser beam (Lc) on a terminating end (12; 22) of the lap welding.

When the laser beam is irradiated again onto the metal portion once brought into a molten state by the laser welding, the metal in the molten state is scattered, so that burn-through, and the like, is caused. However, when the laser irradiation is interrupted even for a very short time period, the cooling of molten metal and the thermal diffusion to the peripheral portion of the molten metal are promoted. Thus, when, after the interruption of the laser irradiation, a defocused laser beam having reduced energy density and an increased spot diameter is irradiated, the non-molten metal around the molten metal can be melted without the molten metal being scattered, and the recessed section at the welding terminating end is filled and flattened by the newly produced molten metal flowing into the recessed section.

Furthermore, since the substantial welding length to the terminating end of the weld bead is secured, it is not necessary that, as in the conventional welding method, the welding length be reduced to prevent the formation of a hole and an indentation at the welding terminating end, and that the weld bead be extended to avoid the reduction in the welding length. Thereby, it is possible to prevent an increase in the space required for the welding. Furthermore, since the focus adjustment of the laser can be performed during the interruption of the laser irradiation, and since the interruption time period is very short (about 30 to 50 milliseconds in a practical example), the interruption of laser irradiation hardly affects the welding cycle time.

It is preferred that the welding method according to the present invention include: performing lap welding (11; 21) by irradiating the laser beam (La) on a plurality of overlapped workpieces (1, 2); then interrupting the laser irradiation for a very short time period and performing, during the interruption time period, movement (Lb) of the laser optical axis from the terminating end (e) of the lap welding to the side of the starting end of the lap welding; and irradiating the defocused laser beam (Lc) from the position (cs) to which the laser optical axis is moved, on the terminating end (e) of the lap welding.

As a form of irradiating the defocused laser beam to the lap welding terminating end, a form can also be considered in which the defocused laser beam is irradiated while being moved in the opposite direction from the terminating end to the starting end. However, as described above, it is possible to minimize the interruption time period of laser irradiation in such a manner that the laser optical axis is moved to the side of the starting end, on which side the laser irradiation has been performed earlier than on the side of the terminating end and also the thermal diffusion has already started, and that the defocused laser beam is then irradiated from the position to which the laser optical axis is moved, to the terminating end in the same direction as the direction at the time of the lap welding. Furthermore, in the welding method according to the present invention, the laser optical axis can be moved during the interruption time period of laser irradiation, and hence the cycle time is not affected.

Furthermore, it is more preferred that the irradiation (Lc) of the defocused laser beam is performed at a higher speed than the speed of laser irradiation (La) at the time of lap welding.

When the irradiation of the defocused laser beam is performed at a high speed, the energy supplied to the portion irradiated with the laser beam is reduced. As a result, it is possible to obtain the same effect as the effect obtained when the laser output is reduced. Therefore, there are advantages that the defocus amount of the laser beam can be reduced as compared with the case in which the energy density of the laser beam is reduced only by the defocusing, and that the time required for the irradiation of the defocused laser beam can also be reduced.

In the welding method according to the present invention, it is preferred that the interruption time period of the laser irradiation be 0.025 to 0.25 seconds. When the interruption time period of the laser irradiation is less than 0.025 seconds, the cooling of the molten metal at the terminating end of the lap welding becomes insufficient. Thereby, a burn-through and an indentation are easily caused at the time of irradiation of the defocused laser beam, so that welding quality cannot be maintained. On the other hand, when the interruption time period of the laser irradiation is too long, the cycle time is increased, so that the productivity is lowered. Therefore, it is advantageous for the interruption time period of the laser irradiation to be set to be as short as possible in the range in which stable welding quality can be obtained.

As described above, with the laser lap welding method according to the present invention, it is possible to reliably prevent the formation of a hole and an indentation at the welding terminating end while avoiding an increase in the space required for securing the welding length and an increase in the cycle time. Thus, the laser lap welding method according to the present invention is advantageous to improve the quality of laser lap welding.

### BRIEF DESCRIPTION OF THE DRAWINGS

FIG. 1 includes FIG. 1(A) which is a plan view showing a laser scan in a laser lap welding method according to a first embodiment of the present invention, FIG. 1(B) which is a plan view showing a bead shape, FIG. 1(C) which is a graph showing the laser output and the defocus amount, FIG. 1(D) which is a graph showing the laser scan speed, FIG. 1(E) which is a sectional side view of a lap-welded portion, and FIG. 1(F) which is a cross-sectional view of a lap welding terminating end;

FIG. 2 includes FIG. 2(A) which is a plan view showing a weld bead before irradiation of a defocused laser beam in a laser lap welding method according to a second embodiment of the present invention, FIG. 2(B) which is a cross-sectional view along the line B-B in FIG. 2(A), FIG. 2(C) which is a plan view showing a weld bead after irradiation of the defocused laser beam, and FIG. 2(D) which is a cross-sectional view along the line B-B in FIG. 2(C);

FIG. 3 is a graph showing a relationship between the defocus amount and the indentation depth in each of the cases in which the gap between workpieces is set to (a) 0.2 mm, (b) 0.1 mm, and (c) 0.05 mm;

FIG. 4 is a graph showing a relationship between the laser irradiation interruption time and the indentation depth;

FIG. 5 is a graph showing a relationship between the defocus amount, the laser beam diameter, and the bead width at the lap welding terminating end; and

FIG. 6 includes FIG. 6(A) which is a sectional side view showing a conventional laser lap welding method, FIG. 6(B) which is a plan view showing the conventional laser lap welding method, FIG. 6(C) which is a graph showing the laser output, and FIG. 6(D) which is a sectional side view showing another conventional laser lap welding method.

### DETAILED DESCRIPTION OF THE INVENTION

In the following, embodiments according to the present invention will be described in detail with reference to the accompanying drawings.

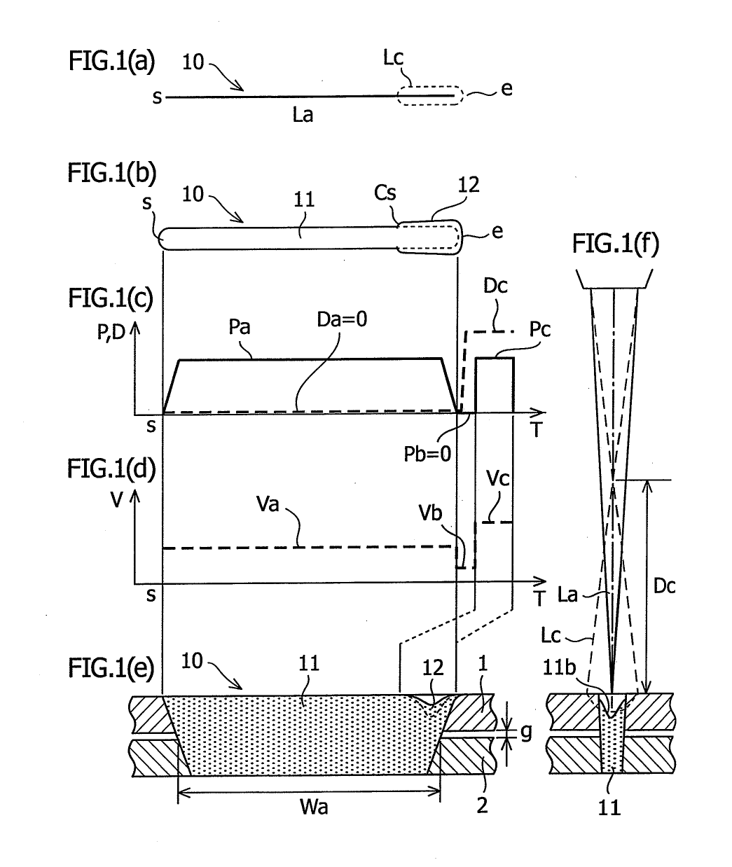

FIG. 1 shows a case in which laser lap welding 10 according to a first embodiment is performed on two steel sheets 1 and 2 (galvanized steel sheets), so as to form a linear welding portion having a predetermined length. In this case, the two steel sheets 1 and 2 are overlapped via, for example, embossments (protrusions, not shown) press formed in advance on one side (or both sides) of the steel plates, and thereby the two steel sheets 1 and 2 are held with jigs (not shown), such as clamps, in the state in which a tiny gap g for discharging zinc vapor is formed between the two steel sheets 1 and 2. Note that the gap g may be formed by spacers, or the like, instead of forming the embossments. Furthermore, in the case in which no galvanized layer exists on the joining surface of the two steel sheets 1 and 2, or in which the two steel sheets 1 and 2 are not provided with a layer plated with a low melting point metal, such as zinc, the two steel sheets 1 and 2 may be directly overlapped without forming the gap g.

In the case in which the laser lap welding 10 is performed, a weld bead 11 penetrating the two steel sheets 1 and 2 in the thickness direction is first formed by performing laser irradiation La at a constant laser output Pa and a constant scanning speed Va with a defocus amount Da=0 (in a just focus state) from a starting end s to a terminating end e. Next, as shown in FIG. 1C, the laser irradiation is interrupted for a very short time period, that is, movement Lb of the laser optical axis to a point cs on the side of the starting end s is performed at laser output Pb=0. At the same time, the focus control of the laser is performed to set the defocus amount to Dc, so that, at predetermined laser output Pc and scanning speed Vc, defocused laser irradiation Lc is performed so as to overlap with the weld bead 11 from the point cs to which the laser optical axis is moved, to the terminating end e.

In this case, at the time when the laser irradiation La is terminated, a recessed section 11b (transient indentation) is left at the terminating end e of the weld bead 11 as shown by the solid line in FIG. 1(F). However, after the laser irradiation is interrupted for a very short time period, the laser irradiation Lc is performed in such a manner that the energy density is reduced and the spot diameter is increased by the defocusing as shown by the broken line in FIG. 1(F). Thereby, the non-molten metal around the recessed section 11b is melted and flows into the recessed section 11b, as a result of which the recessed section 11b is filled and thereby the welding terminating end 12 is flattened.

The defocus amount Dc is not limited in particular, but it is preferred to set the defocus amount Dc such that, as shown in the graph of FIG. 5, a bead width Bc, which is about 1.5 to 2 times the width Ba of the weld bead 11, is obtained at the welding terminating end 12. Furthermore, the length (cs−e) of the defocused laser irradiation Lc is not limited in particular, but needs to be set to the length of about 2 times the width (Ba) of the weld bead 11, and is preferably set to 3 times or more the width (Ba) of the weld bead 11.

Note that, when laser output control, in which, as shown in FIG. 1(C), the laser output is gradually increased to the predetermined laser output Pa at starting end s of the laser irradiation La and is gradually reduced from the laser output Pa to Pb=0 at the terminating end e of the laser irradiation La, is used together with the focus control of the laser, the substantial welding length Wa becomes slightly shorter than the length of the weld bead 11 formed on the surface of the welded portion, but the depth of the recessed section 11b temporarily formed at the terminating end e of the weld bead 11 is reduced. The reduction in the depth of the recessed section 11b is advantageous for flattening the welding terminating end 12 by the defocused laser irradiation Lc. Also, in this case, there is an advantage that the permissible range of other welding conditions, such as the scanning speed Vc, the defocus amount Dc, and the interruption time of laser irradiation, is increased. However, in the defocused laser irradiation Lc, the substantial power density is reduced, and hence the output control is unnecessary.

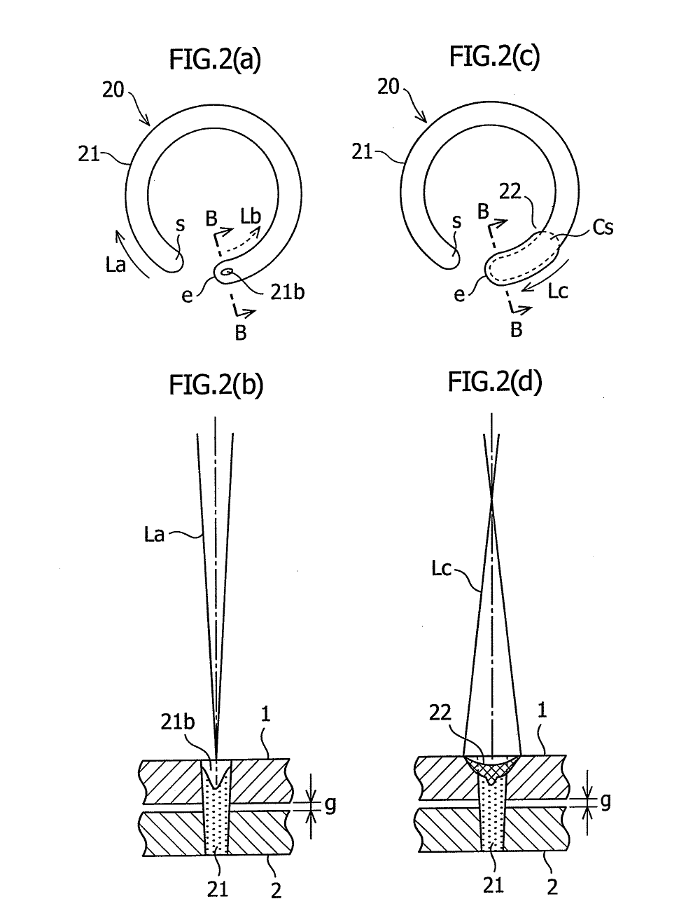

Next, FIG. 2 includes FIG. 2(A) which is a plan view showing a weld bead 21 before defocused laser irradiation in laser lap welding 20 according to a second embodiment of the present invention, FIG. 2(B) which is a cross-sectional view along the line B-B in FIG. 2(A), FIG. 2(C) which is a plan view showing weld beads 21 and 22 after the defocused laser irradiation, and FIG. 2(D) which is a cross-sectional view along the line B-B in FIG. 2(C). The laser lap welding 20 according to the second embodiment shows an embodiment which forms a circular weld bead (C-shaped weld bead) having an opened portion, and which is particularly suitable for laser welding (unit welding) as an alternative to spot welding in an automotive vehicle body welding process.

The welding procedure of the laser lap welding 20 is the same as that of the laser lap welding 10 according to the above-described first embodiment except that the laser scan is performed in a partially opened ring shape. The reason why a laser scan is not performed in a closed ring shape, but is performed in a partially opened ring shape, is that the laser scan is performed so that the discharge path of the zinc vapor in the space surrounded by bead 20 is secured between the starting end s and the terminating end e of the laser scan performed to again approach the starting end s.

As shown in FIG. 2(A) and FIG. 2(C), a recessed section 21b (transient indentation) is formed at the terminating end e of the weld bead 21 at the time of terminating the laser irradiation La. However, when, after the laser irradiation is interrupted for a very short time period, the defocused laser irradiation Lc, in which the spot diameter is increased, is performed as shown in FIG. 2(A) and FIG. 2(B), the non-molten metal around the terminating end e is melted and flows into the recessed section 11b, and thereby the welding terminating end section 22 is flattened so that the excellent weld bead 20 is obtained.

When the laser lap welding according to the present invention is performed as a laser welding process alternative to a spot welding process in an automotive vehicle body welding process, and the like, the welding process is performed intermittently at suitable intervals by using, as a unit welding process, the linear laser welding 10 according to the above-described first embodiment or the circular laser welding 20 according to the above-described second embodiment. In such welding process, it is also possible that, during the interruption time of laser irradiation after the laser lap welding La at a freely chosen welding spot is completed, the laser lap welding La of another welding spot adjacent to the welding spot is performed, and then the defocused laser irradiation Lc is performed to the previous welding spot.

### Example

In order to verify the effect of the laser lap welding method according to the present invention, experiments were performed in the laser lap welding 20 according to the second embodiment described above, and the quality of the weld bead was evaluated by changing the defocus amount Dc of the laser irradiation Lc in a range of 15 to 50 mm in each of the cases of the gap g between workpieces being (a) g=0.2 mm, (b) g=0.1 mm, and (c) g=0.05 mm.

In the experiments, an optical fiber laser oscillator (having a maximum output: 7 kW, a diameter of transmission fiber: 0.2 mm) manufactured by IPG photonics company, and a scanner head (having a processing focal diameter in the focused state: 0.6 mm) manufactured by HIGHYAG laser technology company were used.

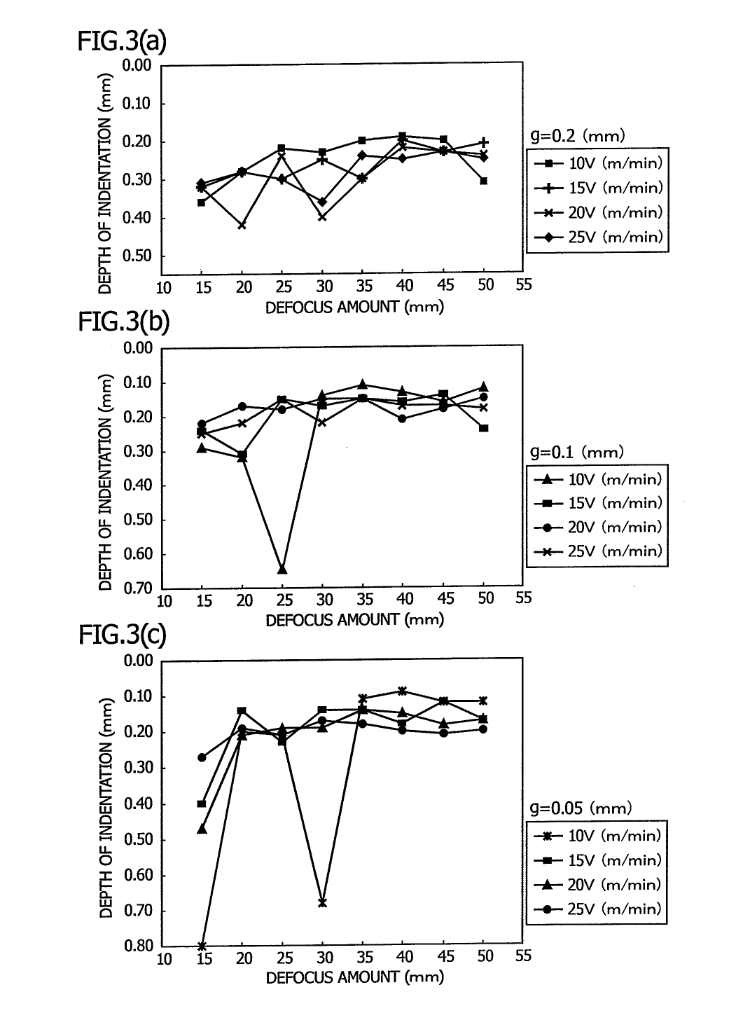

In each of the states in which, as a workpiece, a non-plated steel sheet (1) having a thickness of 0.65 mm was overlapped on a galvanized steel sheet (2) having a thickness of 0.8 mm with the above-described gaps g, when the circular laser scan La was performed under the conditions of the laser output: 4.3 kW, the laser beam diameter: 7 mm, the length of the discontinuous portion: 1 mm, the set welding length: 21 mm, the scanning speed: Va=6.9 m/min (first half) to 7.2 m/min (second half), and when, after the interruption time period of 0.03 seconds, the defocused laser scan Lc was performed by changing the scanning speed Vc respectively to 10, 15, 20 and 25 m/min, the depth of indentation finally left in the welding terminating end section 22 was measured. The results of the experiments are shown in FIG. 3.

From the graph of FIG. 3(A), it was confirmed that, in the setting in which a comparatively large gap of g=0.2 mm is secured between workpieces, the depth of indentation is 0.4 mm or less in most of the range of the defocus amount Dc=15 to 50 mm used for the experiment, and hence the shape of the welding terminating end section 22 is improved to be within the practical range of welding quality.

Furthermore, from each of the graphs of FIG. 3(B) and FIG. 3(C), it was confirmed that, when each of comparatively small gaps of g=0.1 mm and 0.05 mm is set between workpieces, and when the scanning speed Vc is set to 15 m/min (double speed) or more, it is possible to obtain very good results that the depth of indentation is 0.4 mm or less in the range of defocus amount Dc=15 to 50 mm, and that the depth of indentation is 0.25 mm or less in the range of defocus amount Dc=25 to 50 mm. This indicates that a smaller gap g is fundamentally advantageous to suppress the formation of indentation because when the gap g is smaller, the amount of molten metal entering into the gap g is smaller.

On the other hand, when the scanning speeds Vc was set to 10 m/min close to the scanning speed Va, and when the defocus amount Dc was set in a small range of 30 mm or less, a burn-through was caused. It is inferred that this is because the substantial power density was not sufficiently reduced, and hence the discharge of zinc vapor and the thermal diffusion were insufficient. Therefore, when a small gap g is set between the two steel sheets 1 and 2, the substantial power density in the laser irradiation Lc may be sufficiently reduced by increasing the defocus amount Dc (to 35 mm or more), or by increasing the scanning speed Vc (to the double speed or more of the scanning speed Va).

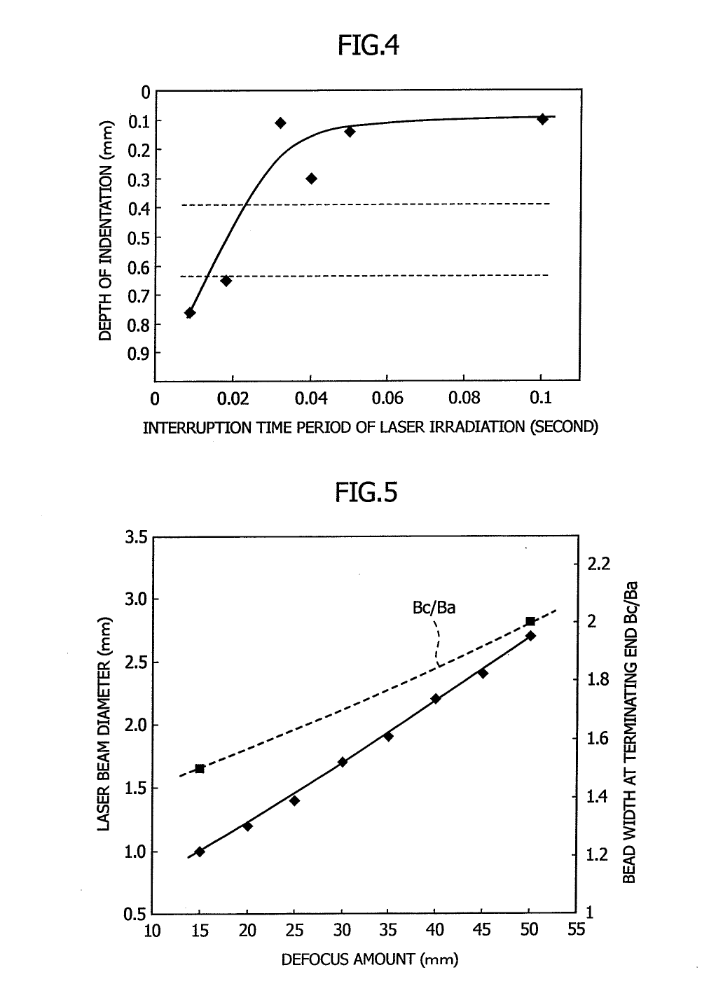

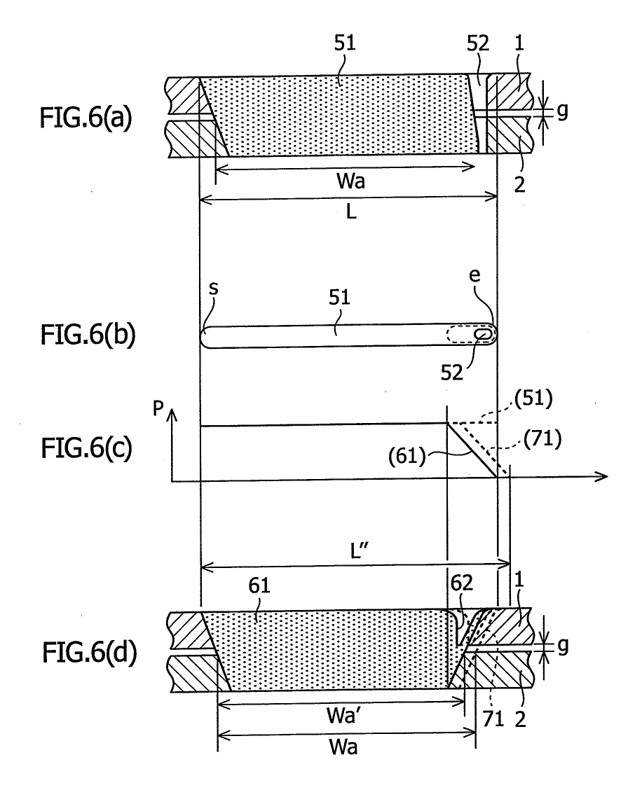

Next, an experiment was performed to investigate the influence of the interruption time period of laser irradiation on the welding quality in the laser lap welding 20 according to the second embodiment described above. In the experiment in which the same welding apparatus and workpieces as those described above were used, when the circular laser scan La was performed under the conditions: the gap g=0.2 mm and the scanning speed of Va=6.9 in/min (first half) to 7.2 m/min (second half), and when, after the interruption time period (0.009 to 0.100 seconds), the defocused laser scan Lc was performed at the scanning speed Vc=15 m/min, and the defocus amount of Dc=50 mm, the depth of indentation finally left in the welding terminating end section 22 was measured. The results of the experiments are shown in FIG. 4.

From the graph of FIG. 4, in each of the samples of the laser irradiation interruption time period of 0.009 seconds and 0.018 seconds, a burn-through caused by an indentation penetrating the upper steel sheet (1) was confirmed. However, in any of the other samples, the depth of indentation was 0.3 mm or less, and hence good results were obtained. In consideration of the depth of indentation of about 0.4 mm being permitted for the upper steel sheet (1) having a thickness of 0.65 mm, it can be said that stable welding quality is obtained in the case of laser irradiation interruption time period of 0.025 seconds or more.

In the above, some embodiments according to the present invention have been described, but the present invention is not limited to the above described embodiments, and various modifications and changes can be made on the basis of the technical concept of the present invention.

For example, in each of the above-described embodiments, the case is described in which the movement Lb of the laser optical axis is performed to the side of the starting end during the interruption time period of laser irradiation, and in which the defocused laser irradiation is then performed from the point cs to which the laser optical axis is moved, to the terminating end e. However, the defocused laser irradiation can also be performed from the terminating end e to the side of the starting end s. In this case, it is necessary that the interruption time period of laser irradiation be set to be slightly longer than the interruption time period in the above-described embodiments.

Furthermore, in each of the above-described embodiments, the case is described in which the two steel sheets are overlapped and laser-welded. However, the laser lap welding method according to the present invention can also be applied to a workpiece having another form, and can also be applied to the case in which three or more steel sheets are overlapped and laser-welded. Furthermore, the cases in which the weld bead has a linear shape and a circular shape (circular arc shape) are shown in the above-described embodiments, but the laser lap welding method according to the present invention can be applied to an arbitrary shape of the weld beam other than these shapes of the weld bead.

What is claimed is:

1. A laser lap welding method comprising the steps of:
performing lap welding by irradiating a laser beam on a plurality of overlapped workpieces;
interrupting the irradiation of the laser beam for a very short time period after the step of performing lap welding; and
irradiating a defocused laser beam on a terminating end of the lap welding after the step of interrupting the irradiation of the laser beam.

2. A laser lap welding method comprising the steps of:
performing lap welding by irradiating a laser beam on a plurality of overlapped workpieces;
interrupting the irradiation of the laser beam for a very short time period after the step of performing lap welding, and moving the optical axis of the laser beam from the terminating end of the lap welding to the side of the starting end of the lap welding during the interruption of irradiation of the laser beam; and
irradiating, after the step of moving the optical axis of the laser beam, a defocused laser beam from the position to which the optical axis of the laser beam is moved, to the terminating end of the lap welding.

3. The laser lap welding method according to claim 1, wherein the step of irradiating the defocused laser beam is performed at a speed higher than the speed of the laser beam irradiation in the step of performing the lap welding.

4. The laser lap welding method according to claim 2, wherein the step of irradiating the defocused laser beam is performed at a speed higher than the speed of the laser beam irradiation in the step of performing the lap welding.

5. The laser lap welding method according to claim 1, wherein the interruption time period of the laser beam irradiation is in a range of 0.025 to 0.25 seconds.

6. The laser lap welding method according to claim 2, wherein the interruption time period of the laser beam irradiation is in a range of 0.025 to 0.25 seconds.

7. The laser lap welding method according to claim 3, wherein the interruption time period of the laser beam irradiation is in a range of 0.025 to 0.25 seconds.

8. The laser lap welding method according to claim 4, wherein the interruption time period of the laser beam irradiation is in a range of 0.025 to 0.25 seconds.
